(19) United States
(12) Patent Application Publication
(10) Pub. No.: US 2020/0261940 A1
(43) Pub. Date: Aug. 20, 2020

(54) SYSTEM AND METHOD FOR FORMING A GRANULE BED

(71) Applicant: IVC, BV, Avelgem (BE)

(72) Inventor: Matthew Drobnick, Calhoun, GA (US)

(21) Appl. No.: 16/757,586

(22) PCT Filed: Oct. 22, 2018
(86) PCT No.: PCT/US2018/056909

§ 371 Date: Apr. 20, 2020

Related U.S. Application Data
(60) Provisional application No. 62/575,592, filed on Oct. 23, 2017.

(51) Int. Cl. B05C 19/06; B05C 19/04

(52) U.S. Cl. CPC B05C 19/06; B05C 19/04

(57) ABSTRACT

An automated granule bed forming mechanism may be utilized to form granule beds that are ultimately melted, compressed, and/or set to form an at least substantially continuous sheet. The automated granule bed forming mechanism may comprise a support conveyor configured for supporting the formed granule bed and a granule dispenser having a plurality of individually controllable feed chutes positioned across a width of the support conveyor, wherein each of the plurality of feed chutes are configured to dispense granules onto the support conveyor to collectively form the granule bed. A monitoring mechanism detects the thickness of the generated granule bed, and a controller compares the detected thickness against a target thickness profile and transmits signals to one or more of the individually controllable feed chutes to adjust the flowrate of granules onto the support conveyor.

### BACKGROUND

The formation of various panel-based structures, such as floor panels, wall panels, ceiling panels, and/or the like may incorporate steps for forming a bed of one or more thermoplastic or thermoset plastics that is later melted and/or pressed into a thin panel structure. For example, as described in WIPO Publication No. WO 2016/079225, the contents of which are incorporated herein by reference in their entirety, a flooring panel may be formed by forming a thermoplastic granule bed on a moving conveyor, laying a reinforcing layer onto the granule bed, and heating and pressing the thermoplastic granule bed and the reinforcing layer to melt the thermoplastic granules and to bond the reinforcing layer relative to the thermoplastic layer formed by the melted granules. The process may be repeated by forming a bed of granules on top of the formed laminate structure, and again heating and pressing the granules to bond the laminated structure relative to the formed plastic layer of the melted granules. The reinforced thermoplastic layers can then bonded to together along with a surface layer to form finished articles. For example, the surface layer could be made from PVC and the finished articles are luxury vinyl tiles (LVT) for flooring uses.

Often, it is desirable to form these granule beds with an at least substantially uniform thickness across the width of the granule bed to ultimately generate a melted layer having an at least substantially uniform thickness. However, existing granule spreading mechanisms are generally incapable of providing an at least substantially uniform granule bed thickness due to variations in granule size, granule dust build-up around an exit feed of the granule spreader, and/or the like. Accordingly, a need exists for granule spreading mechanisms configured for providing a granule bed having desirable thickness characteristics.

### BRIEF SUMMARY

Various embodiments are directed to an automated granule bed feed mechanism comprising a closed-loop feedback system for monitoring a formed thickness of a granule bed and for adjusting the rate of granule feeding to the granule bed to more closely target a desired granule bed thickness profile. The granule bed feed mechanism comprises a granule bin positioned above a moving conveyor, and having a plurality of feed chutes positioned across the width of the moving conveyor. The plurality of feed chutes have controllable feed doors that may be selectably opened to enable granules to flow from the granule bin, through the feed chutes, and onto the conveyor belt. Each feed chute is configured to provide granules onto a corresponding lane of the conveyor belt, and each feed door may be independently operable to adjust the amount of granules flowing onto a particular lane of the conveyor.

The granule bed feed mechanism is operable based at least in part on detection signals received from a granule bed monitoring mechanism configured to monitor the formed thickness of the granule bed and compare the thickness against a target thickness profile. The individual feed doors of the various feed chutes may be operated to permit more or less material granules to flow onto the moving conveyor to change the thickness of various portions of the granule bed to more closely match a desired thickness profile.

Certain embodiments are directed to an automated granule bed forming mechanism comprising: a support conveyor configured for supporting a formed granule bed; a granule dispenser configured for dispensing granules onto the support conveyor to form a granule bed, the granule dispenser comprising: a plurality of feed chutes positioned across a width of the support conveyor, each of the plurality of feed chutes having an individually controllable feed door for controlling the flow rate of granules from the feed chute onto the support conveyor; a thickness monitoring mechanism configured to monitor the thickness of the granule bed on the support conveyor; and a controller configured to: compare the detected thickness of the granule bed on the support conveyor relative to a target thickness profile; and transmit signals to one or more of the individually controllable feed doors to adjust the flow rate of granules from the feed chute onto the support conveyor to adjust the thickness of the granule bed to correspond to the target thickness profile.

In various embodiments, each of the feed chutes are configured to dispense granules onto a corresponding lane of the support conveyor; and the controller is configured to: compare the detected thickness of the granule bed in each lane of the support conveyor relative to a target thickness profile; and transmit a signal to an individually controllable feed door of a particular feed chute to adjust the flow rate of granules from the feed chute onto the corresponding lane. Moreover, each of the plurality of individually controllable feed doors may be movable via a corresponding motor. In certain embodiments, each motor comprises a feedback mechanism (e.g., force feedback) configured to detect resistive forces counteracting a desired movement of the motor. As yet another example, the feedback mechanism may comprise a position feedback mechanism configured to detect the position of the feed door between the open and closed configurations. Moreover, the target thickness profile may define an at least substantially uniform thickness across a width of the granule bed. In certain embodiments, the target thickness profile defines a non-uniform thickness across a width of the granule bed.

According to a first aspect of the invention, an automated granule bed forming mechanism is provided, which mechanism comprising:

a support conveyor configured for supporting a formed granule bed;

at least one granule dispenser configured for dispensing granules onto the support conveyor to form a granule bed, wherein the granule dispenser comprises:
a plurality of feed chutes positioned across a width of the support conveyor, each of the plurality of feed chutes having an individually controllable feed door for controlling the flow rate of granules from the feed chute onto the support conveyor;
a thickness monitoring mechanism configured to monitor the thickness of the granule bed on the support conveyor; and

one or more controller configured to:
compare the detected thickness of the granule bed on the support conveyor relative to a target thickness profile; and
transmit signals to one or more of the individually controllable feed doors to adjust the flow rate of granules from the feed chute onto the support conveyor to adjust the thickness of the granule bed to correspond to the target thickness profile.

According to some embodiments, the mechanism may comprise a plurality of granulate dispensers, and wherein the one or more controller is embodied as a single controller configured to transmit signals to one or more of the individually controllable feed doors of each of the plurality of granulate dispensers.

According to some embodiments, the mechanism may comprise a plurality of granulate dispensers, and wherein the one or more controller is embodied as a plurality of controllers, each of the plurality of controllers is configured to transmit signals to one or more of the individually controllable feed doors of one or more of the plurality of granulate dispensers.

According to some embodiments, the mechanism may comprise a plurality of granulate dispensers, and wherein the one or more controller is embodied as a plurality of controllers, wherein each of the plurality of controllers corresponds to a corresponding controller of the plurality of granule dispensers, and wherein each of the plurality of controllers is configured to transmit signals to one or more of the individually controllable feed doors of the corresponding granule dispenser.

According to some embodiments, each of the feed chutes may be configured to dispense granules onto a corresponding lane of the support conveyor; and the one or more controller being configured to:
compare the detected thickness of the granule bed in each lane of the support conveyor relative to a target thickness profile; and
transmit a signal to an individually controllable feed door of a particular feed chute to adjust the flow rate of granules from the feed chute onto the corresponding lane.

According to some embodiments, the target thickness profile may define an at least substantially uniform thickness across a width of the granule bed.

According to some embodiments, the target thickness profile may define a non-uniform thickness across a width of the granule bed.

According to some embodiments, each of the plurality of individually controllable feed doors may be movable via a corresponding motor. According to some embodiments, each motor may comprise a feedback mechanism configured to detect resistive forces counteracting a desired movement of the motor. According to some embodiments, the feedback mechanism may comprise a force feedback mechanism According to some embodiments, the feedback mechanism may comprise a position feedback mechanism configured to detect the position of the feed door between the open configuration and the closed configuration.

According to a second aspect of the invention, a method for forming a granule bed is provided, the method comprising:
moving a support conveyor past at least one granule dispenser;
dispensing granules from a plurality of feed chutes positioned across a width of the support conveyor to form a granule bed, wherein each of the plurality of feed chutes has an individually controllable feed door for controlling the flow rate of the granules flowing from the feed chute onto the support conveyor;
detecting the thickness of the granule bed via a thickness monitoring mechanism;
comparing the detected thickness of the granule bed relative to a target thickness profile; and
adjusting one or more of the feed doors of the plurality of feed chutes to adjust the flow rate of granules from the feed chute onto the support conveyor to adjust the thickness of the granule bed to correspond to the target thickness profile.

According to some embodiments, the method of the invention may comprise the use of one or more controllers to:
detect the thickness of the granule bed relative to a target thickness profile; and
adjust one or more of the feed doors of the plurality of feed chutes to adjust the flow rate of granules from the feed chute onto the support conveyor to adjust the thickness of the granule bed to correspond to the target thickness profile.

According to some embodiments, the method of the invention may comprise the use of a plurality of consecutive granulate dispensers, and using one controller to:
detect the thickness of the granule bed relative to a target thickness profile; and
adjust one or more of the feed doors of the plurality of feed chutes of all granulate dispensers to adjust the flow rate of granules from the feed chute onto the support conveyor to adjust the thickness of the granule bed to correspond to the target thickness profile.

According to some embodiments, the method of the invention may comprise the use of a plurality of consecutive granulate dispensers, and using one controller to:
detect the thickness of the granule bed relative to a target thickness profile; and
adjust one or more of the feed doors of the plurality of feed chutes of some granulate dispensers to adjust the flow rate of granules from the feed chute onto the support conveyor to adjust the thickness of the granule bed to correspond to the target thickness profile.

According to some embodiments, the method of the invention may comprise the use of a plurality of consecutive granulate dispensers, and using a controller to:
detect the thickness of the granule bed relative to a target thickness profile; and
adjust one or more of the feed doors of the plurality of feed chutes of said granulate dispensers to adjust the flow rate of granules from the feed chute onto the support conveyor to adjust the thickness of the granule bed to correspond to the target thickness profile.

According to some embodiments, the step of dispensing granules from a plurality of feed chutes may comprise dispensing granules into a plurality of lanes on the support conveyor, wherein each feed chute of the plurality of feed chutes corresponds to a single lane of the plurality of lanes; and/or wherein the step of comparing the detected thickness of the granule bed relative to the target thickness may comprise comparing the detected thickness of the granule bed in each lane relative to the target thickness profile.

According to some embodiments, the target thickness profile may define an at least substantially uniform thickness across a width of the granule bed.

According to some embodiments, the target thickness profile may define a non-uniform thickness across a width of the granule bed.

According to some embodiments, the step of adjusting one or more of the feed doors of the plurality of feed chutes may comprise actuating a motor corresponding to each of the one or more feed doors.

According to some embodiments, the method further may comprise receiving a feedback signal from one or more of the motors to detect a position of the one or more feed doors; and wherein adjusting one or more of the feed doors comprises moving the one or more of the feed doors to a desired position based at least in part on the feedback signal.

The methods according to the second aspect of the invention may make use of automated granule bed forming mechanisms according to the first aspect of the invention.

According to a third aspect of the invention, a controller for an automated granule bed forming mechanism is provided, the controller comprising one or more memory storage areas and at least one processor configured to:

transmit a signal to a plurality of individually controllable feed doors of corresponding feed chutes of a plurality of feed chutes of a granule dispenser to control a flowrate of granules from the feed chute onto a support conveyor, wherein the plurality of feed chutes are positioned across a width of the support conveyor;

detecting a thickness of a granule bed formed on the support conveyor from granules flowing from the plurality of feed chutes;

comparing the detected thickness of the granule bed on the support conveyor relative to a target thickness profile; and

transmitting a second signal to the plurality of individually controllable feed doors to adjust the flowrate of granules from the feed chute.

According to some embodiments, each of the feed chutes may be configured to dispense granules onto a corresponding lane of the support conveyor; and wherein

comparing the detected thickness of the granule bed on the support conveyor relative to the target thickness profile comprises comparing the detected thickness of the granule bed in each lane of the support conveyor relative to the target thickness profile; and

transmitting the second signal to the plurality of individually controllable feed doors comprises transmitting the second signal to the plurality of individually controllable feed doors to adjust the flow rate of granules from the feed chute onto the corresponding lane.

According to some embodiments, the target thickness profile may define an at least substantially uniform thickness across a width of the granule bed.

According to some embodiments, the target thickness profile defines a non-uniform thickness across a width of the granule bed.

According to some embodiments, the at least one processor may be additionally configured to receive a feedback signal from one or more feed doors; and

wherein adjusting one or more of the feed doors comprises moving the one or more of the feed doors to a desired position based at least in part on the feedback signal.

According to some embodiments, the controller may be fit to transmit signals to a plurality of individually controllable feed doors of corresponding feed chutes of a plurality of feed chutes of one granule dispenser.

According to some embodiments, the controller may be fit to transmit signals to a plurality of individually controllable feed doors of corresponding feed chutes of a plurality of feed chutes of more than one granule dispenser.

The methods according to the second aspect of the invention may make use of one or more controllers according to the third aspect of the invention.

The automated granule bed forming mechanisms according to the first aspect of the invention may comprise of one or more controllers according to the third aspect of the invention.

According to a fourth aspect of the invention, a method to make a thermoplastic or thermoset sheet is provided, the method comprising the steps of
providing thermoplastic or thermoset granules;
forming a granule bed using a method according to the first aspect of the invention;
consolidating said bed of granules to a sheet of thermoset of thermoplastic material by applying pressure and/or temperature to the bed of granules;
optionally cooling said sheet of thermoset of thermoplastic material;
optionally adding additional layers of material to the sheet.

According to some embodiments, the additional layers may be added by laminating such as thermal laminating, and/or by gluing the layers to the substrate.

According to some embodiments, the thermoplastic or thermoset sheet may be a floor covering or floor covering element.

According to some embodiments, adding additional layers may comprise adding a decorative layer and adding a wear layer to the thermoplastic or thermoset sheet.

According to some embodiments, the decorative layer may be a printed film, such as a printed PVC or PU film, wherein PVC stands for polyvinyl chloride and PU stands for polyurethane. The wear layer may be a transparent or translucent PVC layer.

According to some embodiments, adding additional layers may comprise laminating a decorative layer and a wear layer to the thermoplastic or thermoset sheet.

According to some embodiments, the method may further comprise the addition of a lacquering layer to the wear layer. This may be an UV curing PU lacquering layer.

According to a fifth aspect of the invention, a method to make a floor covering element is provided, the method comprising the use of a method according to the fourth aspect of the invention. The sheet, obtained by a method according to the fourth aspect of the invention, may further be cut into parts, typically rectangular parts, which parts, being floor covering elements, may be provided with mechanical coupling means to couple two or more elements to each other along their sides.

The independent and dependent claims set out particular and preferred features of the invention. Features from the dependent claims may be combined with features of the independent or other dependent claims, and/or with features set out in the description above and/or hereinafter as appropriate.

The above and other characteristics, features and advantages of the present invention will become apparent from the following detailed description, taken in conjunction with the accompanying drawings, which illustrate, by way of example, the principles of the invention. This description is given for the sake of example only, without limiting the scope of the invention. The reference figures quoted below refer to the attached drawings.

### BRIEF DESCRIPTION OF THE SEVERAL VIEWS OF THE DRAWINGS

Reference will now be made to the accompanying drawings, which are not necessarily drawn to scale, and wherein:

FIG. 1 shows a schematic diagram of a panel production line incorporating granule feed mechanisms according to one embodiment;

FIG. 2 shows a perspective view of a granule feed mechanism according to one embodiment;

FIG. 3 shows a perspective view of a thickness monitoring mechanism according to one embodiment;

FIG. 4 shows an example controller display output according to one embodiment;

FIG. 5 is a schematic diagram illustrating data transmissions between various components according to one embodiment;

FIGS. 6A-6B show a schematic diagrams of a panel production line incorporating granule feed mechanisms according to various embodiments; and

FIGS. 7-8 show cross-sectional views of multi-layer structures formed via panel production lines according to various embodiments.

The same reference signs refer to the same, similar, or analogous elements in the different figures.

### DETAILED DESCRIPTION

The present disclosure more fully describes various embodiments with reference to the accompanying drawings. It should be understood that some, but not all embodiments are shown and described herein. Indeed, the embodiments may take many different forms, and accordingly this disclosure should not be construed as limited to the embodiments set forth herein. Rather, these embodiments are provided so that this disclosure will satisfy applicable legal requirements. Like numbers refer to like elements throughout.

It is to be noticed that the term “comprising”, used in the claims, should not be interpreted as being restricted to the means listed thereafter; it does not exclude other elements or steps. It is thus to be interpreted as specifying the presence of the stated features, steps or components as referred to, but does not preclude the presence or addition of one or more other features, steps or components, or groups thereof. Thus, the scope of the expression “a device comprising means A and B” should not be limited to devices consisting only of components A and B. It means that with respect to the present invention, the only relevant components of the device are A and B.

Throughout this specification, reference to “one embodiment” or “an embodiment” are made. Such references indicate that a particular feature, described in relation to the embodiment is included in at least one embodiment of the present invention. Thus, appearances of the phrases “in one embodiment” or “in an embodiment” in various places throughout this specification are not necessarily all referring to the same embodiment, though they could.

Furthermore, the particular features or characteristics may be combined in any suitable manner in one or more embodiments, as would be apparent to one of ordinary skill in the art.

Various embodiments are directed to granule bed feed mechanisms that may be used, for example, for generating thermoplastic or thermoset plastic granule beds that may be consolidated, such as by melting, compressing, and/or setting to form an at least substantially continuous thermoplastic or thermoset sheet. The thermoplastic or thermoset granules may comprise flexible, semi-rigid, or rigid polyvinyl chloride (PVC); various polyolefins, (e.g., polypropylene), polyurethane, rubber based compounds, elastomers, mixtures of polymers (e.g., an elastomer and polypropylene mixture), wood-plastic composites (e.g., mixtures comprising wood flour/particles and polymer), and/or the like. In certain embodiments, the thermoplastic or thermoset granules may comprise virgin granule materials and/or recycled granule materials. As discussed herein, a granule bed formed according to various embodiments may comprise a single granule material or may comprise a plurality of granule materials (e.g., virgin and recycled granule materials).

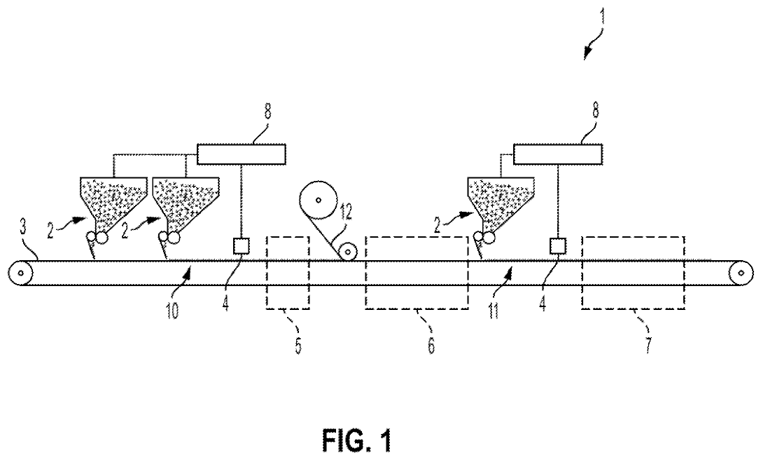

FIG. 1 is a schematic view of an apparatus 1 for continuously processing a web, and illustrates various web processing aspects, including mechanisms for generating and/or processing of one or more granule beds. Such an apparatus 1 may be utilized to generate flooring panels according to certain embodiments. As shown in FIG. 1, the apparatus 1 comprises one or more granule supplies (alternatively referred to herein as granule dispensers) 2 adapted to generate one or more granule beds 10, 11 on a supporting conveyor 3 (e.g., an endless belt) and/or on an upper surface of a reinforcing layer 12. The granule supplies 2 are configured to spread the granules (sometimes called pellets) onto the supporting conveyor 3 according to a defined distribution profile (e.g., a defined thickness profile) across the width of the supporting conveyor 3.

In the illustrated embodiment of FIG. 1, the supporting conveyor 3 is configured to continuously move a first granule bed 10 (formed from one or more granule supplies 2 located at an upstream end of the supporting conveyor) past a first thickness monitoring mechanism 4 and through a first processing portion 5. The first thickness monitoring mechanism 4 is configured to monitor the thickness of the first granule bed 10 (e.g., at various locations across the width of the granule bed 10), which may be utilized to make adjustments to the granule flow from the granule supplies 2 as discussed in greater detail herein. As illustrated, the apparatus 1 may comprise one or more granule supplies 2 located at an upstream end of the supporting conveyor 3, upstream of the first monitoring mechanism 4. In certain embodiments, the apparatus 1 comprises a plurality of granule supplies 2 located at an upstream end of the supporting conveyor 3, and each of these granule supplies 2 may be configured to supply different granule materials. For example, a first granule supply 2 may be configured to provide virgin granules (e.g., comprising a virgin polymer) to the first granule bed 10 and a second granule supply 2 may be configured to provide recycled granules (e.g., comprising a recycled polymer, which may have the same or different underlying polymer characteristics as the virgin polymer) to the first granule bed 10. The granules provided from each of the first granule supply 2 and second granule supply 2 may collectively form the first granule bed 10, and the thickness (and/or other characteristics, such as density) of which may be monitored via the monitoring mechanism 4 located between the most-upstream granule supplies 2 and the first processing portion 5.

The first processing portion 5 may comprise one or more processing mechanisms, such as heating elements, nip rollers, scattering rollers, and/or the like to manipulate the first granule bed 10 prior to applying a reinforcing layer 12 (e.g., a woven, non-woven, and/or grid web material, such as a fiberglass scrim) onto an upper surface of the first granule bed 10. One or more scattering rollers (not shown) having pins formed thereon may be used to help distribute the granules across the machine. The multi-layer structure comprising the first granule bed 10 and the reinforcing layer 12 may then pass through a second processing portion 6 having one or more processing mechanisms to consolidate the first granule bed 10 and to bond the first granule bed 10 and the reinforcing layer 12 (e.g., via melting of the first granule bed 10 to form an at least substantially continuous sheet to adhere to a first side of the reinforcing layer 12).

The laminated multi-layer structure may then pass under a second set of one or more granule supplies 2 configured to form a second granule bed 11 on a top surface of the multi-layer structure (e.g., on a second side of the reinforcing layer 12, opposite the first side). It should be understood that the granule material of the second granule bed 11 may be the same or different from the granule material of the first granule bed 10. The supporting conveyor 3 is configured to continuously move the multi-layer structure (including the second granule bed 11) past a second monitoring mechanism 4 (e.g., configured to detect the thickness, density, and/or the like of the multi-layer structure) and through a third processing portion 7. The second monitoring mechanism 4 is configured to monitor the thickness of the second granule bed 11 (e.g., at various locations across the width of the granule bed 11), which may be utilized to make adjustments to the granule flow from the granule supplies 2 as discussed herein.

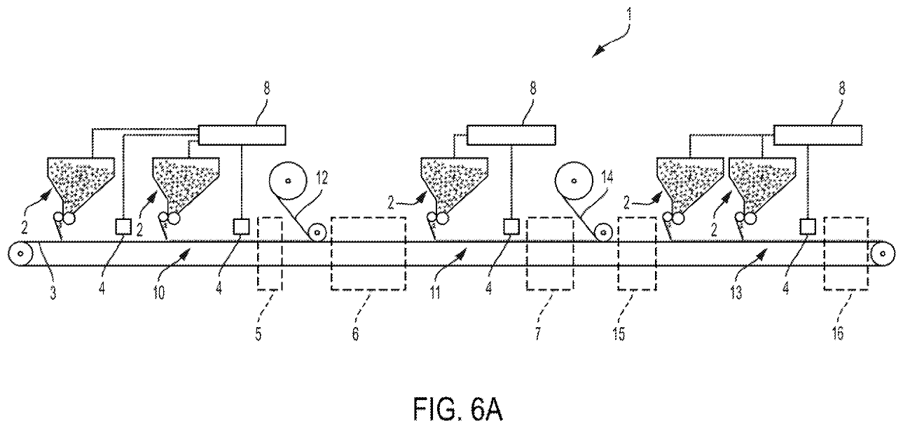

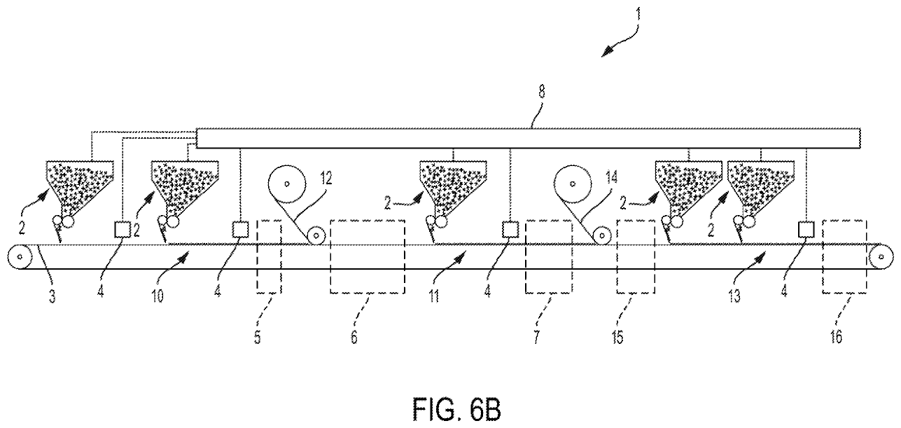

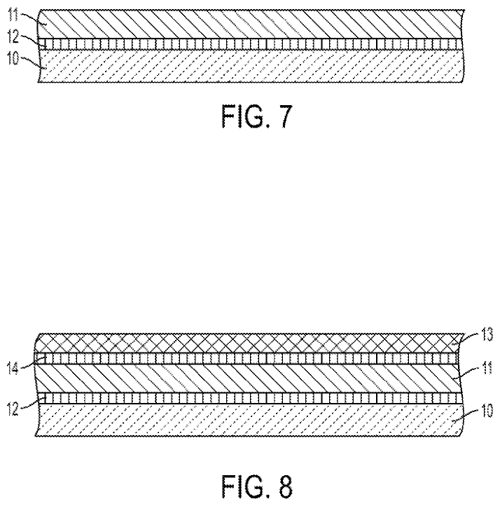

The third processing portion 7 may comprise one or more processing mechanisms, such as heating elements, nip rollers, scattering rollers, and/or the like to secure the second granule bed 11 (e.g., which may comprise the same granule material as the first granule bed 10 or the second granule bed 11 may comprise a different granule material) relative to the other components of the multi-layer structure. As shown in the example embodiments of FIGS. 6A-6B, which illustrate other embodiments of an apparatus 101 having additional granule supplies 2, monitoring mechanisms 4, reinforcing layer supplies, and processing portions, additional layers may be applied to the resulting multi-layer structure. These additional layers may comprise a third granule bed 13, a second reinforcing layer 14, and/or other layers not shown in FIG. 1 or 6A-6B, such as a decorative layer (e.g., a printed PVC layer, a printed PU layer, and/or the like), a clear protective layer (e.g., an ultraviolet cured polyurethane lacquer layer, a clear PVC layer, and/or the like), a durable surface layer, and/or the like. These additional layers may be secured relative to the multi-layer structure via any of a variety of mechanisms, such as heat lamination, adhesive (e.g., a separate adhesive/glue layer provided between various layers to secure those layers together), and/or the like. As FIGS. 6A-6B illustrate, yet other layers may be added to the resulting product via the incorporation of additional corresponding components of an apparatus 1, 101. For example, yet other reinforcing layers and/or granule beds may be added by the incorporation of corresponding granule supplies 2, processing portions, and/or reinforcing layer supplies. Moreover, the multi-layer structure may be cut into individual panels or taken-up onto a storage roller for later processing. In embodiments in which the continuous web of the multi-layer structure is cut into individual panels, those panels may be rectangular floor covering panels and may be provided with mechanical coupling features for coupling two or more adjacent floor panels relative to one another (e.g., along their respective side edges). FIG. 7 illustrates a schematic cross-sectional view of a multi-layer structure formed via the apparatus 1 of FIG. 1, and FIG. 8 illustrates a schematic cross-sectional view of a multi-layer structure formed via the apparatus 101 of FIGS. 6A-6B.

With reference briefly to the configuration of FIGS. 6A-6B, which illustrate various alternative configurations that may be incorporated into an apparatus 101 (it should be understood that various portions/components of apparatus 101 may be incorporated into a relatively less complex apparatus, such as apparatus 1 of FIG. 1), an apparatus 101 may comprise components for forming additional layers and/or may comprise additional monitoring components.

As illustrated in FIGS. 6A-6B a plurality of monitoring mechanisms 4 may be utilized for monitoring the formation of various portions of a granule bed (e.g., granule bed 10, 11, 13). With specific reference to the components illustrated in FIG. 6A, a monitoring mechanism 4 may be placed between a first granule supply 2 and a second granule supply 2 that collectively form the first granule bed 10. Thus, a first monitoring mechanism 4 may be configured to monitor the thickness of a granule bed portion formed by the first granule supply 2, and a second monitoring mechanism 4 may be configured to monitor the collective thickness of the first granule bed 10, as formed by the first granule supply 2 and the second granule supply 2. As will be discussed in greater detail herein, both the first monitoring mechanism 4 and the second monitoring mechanism 4 may be configured to provide detection signals to a single controller 8 (in certain embodiments, separate controllers 8 (as illustrated in FIG. 6A, for example) may be utilized for monitoring each granule bed 10, 11, 13, although in other embodiments a single controller 8 (as illustrated in FIG. 6B, for example) may be utilized for monitoring all granule beds 10, 11, 13), which may be configured to adjust the amount of granule material provided by each of the granule supplies 2. In such configurations, one of the monitoring mechanisms 4 (e.g., the second monitoring mechanism 4, monitoring the collective thickness of the first granule bed 10) may be considered the primary monitoring mechanism, which may cause adjustments to the thickness of the first granule bed 10 by adjusting the amount of granule material provided by both of the first granule supply 2 and the second granule supply 2. The other monitoring mechanism 4 (e.g., the monitoring mechanism positioned between the first granule supply 2 and the second granule supply 2) may be utilized to adjust the relative amount of granule material provided by the first granule supply 2 and the second granule supply 2. For example, detection signals from the first monitoring mechanism 4 may be utilized by the controller 8 to cause the first granule supply 2 to provide more granule material 2 than the second granule supply 2 (or vice versa) to achieve a collective desired thickness of the first granule bed 10. Thus, the relative proportion of granule material provided by the first granule supply 2 may be adjusted relative to the proportion of granule material provided by the second granule supply 2 in forming the first granule bed 10 (similar concepts may be utilized for other granule beds 11, 13).

In FIG. 6B, only one controller 8 is provided with detection signals of all monitoring mechanisms 4, and is fit to adjust the amount of granule material provided by each of the granule supplies 2. It is understood that the detection signal of a particular monitoring mechanism 4 may be used to adjust a granule supply 2 upstream and/or downstream the particular monitoring mechanism 4.

Moreover, as noted above, the apparatus 101 may comprise an additional reinforcing layer 14 supply, additional granule supplies 2, additional monitoring mechanisms 4, additional processing portions (e.g., fourth processing portion 15 for securing the second reinforcing layer 14 relative to the second granule bed 11; and/or fifth processing portion 16 for spreading and/or adhering the third granule bed 13 relative to the second reinforcing layer 14), and/or the like as desired. For example, a fourth processing portion 15 may comprise one or more processing mechanisms to consolidate the second granule bed 11 and to bond the second granule bed 11 and the second reinforcing layer 14 (e.g., via melting of the second granule bed 11 to form an at least substantially continuous sheet to adhere to a first side of the reinforcing layer 14). In such embodiments, the third processing portion 7 may be configured more similarly to the first processing portion 5, and may comprise one or more processing mechanisms, such as heating elements, nip rollers, scattering rollers, and/or the like to manipulate the second granule bed 10 prior to applying the second reinforcing layer 14 (e.g., which may comprise a woven, non-woven, and/or grid web material, such as a fiberglass scrim; and the second reinforcing layer 14 may be the same or different from the first reinforcing layer 12). It should be understood that components the third processing portion 7 and the fourth processing portion 15 may have operating parameters configured to accommodate the presence of the previously processed first granule bed 10 and reinforcing layer 12.

The laminated multi-layer structure, having an exposed second reinforcing layer 14 may then pass under a third set of one or more granule supplies 2 collectively configured to form a third granule bed 13 on a top surface of the second reinforcing layer 14. It should be understood that the third granule bed 13 may be the same or different from the first granule bed 10 and/or the second granule bed 11. The supporting conveyor 3 is configured to continuously move the multi-layer structure (including the third granule bed 13) past a downstream thickness monitoring mechanism 4 and through a fifth processing portion 16. The downstream thickness monitoring mechanism 4 is configured to monitor the thickness of the third granule bed 13 (e.g., at various locations across the width of the granule bed 13), which may be utilized to make adjustments to the granule flow from the granule supplies 2 as discussed herein. Moreover, it should be understood that an additional thickness monitoring mechanism 4 may be incorporated between multiple granule supplies 2 collectively utilized to form the third granule bed 13, in a manner as discussed above in reference to the configuration for forming the first granule bed 10.

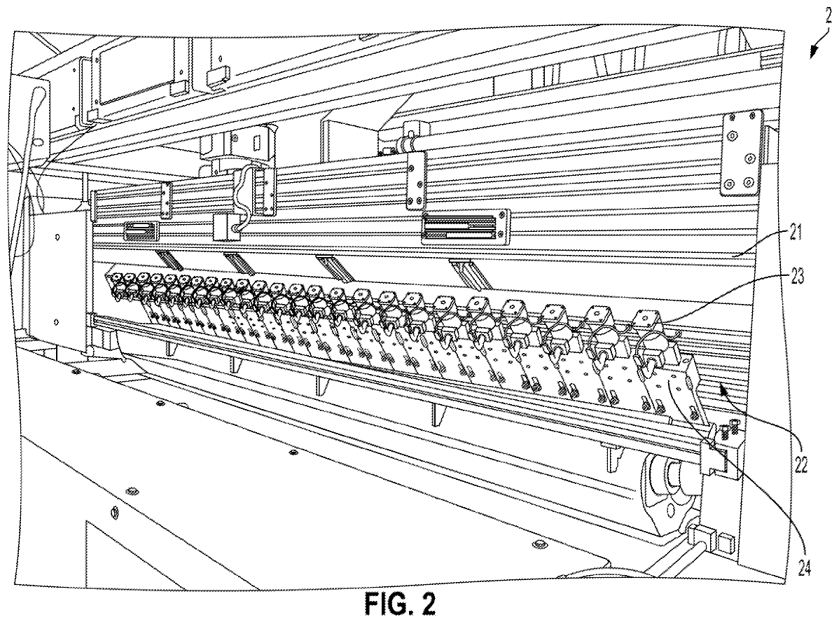

As shown in FIG. 2, which constitutes a perspective view of a granule supply 2 according to one embodiment, the granule supply 2 is positioned above the support conveyor 3 and may comprise a granule supply bin 21 configured to provide granules to a plurality of feed chutes 22 positioned across the width of the support conveyor 3. Each of the feed chutes 22 comprise a mechanically actuated feed door 24 controllable by a corresponding actuator. The actuator may be embodied as a motor 23 as shown in FIG. 2 such as an indexed servo motor, a coil-motor, a solenoid, and/or the like. The actuator may be configured to adjust the position of the feed door 24 relative to the feed chute 22 between a completely closed configuration (preventing a flow of granules through the feed chute 22) and a completely open configuration (allowing a maximum flow rate of granules through the feed chute 22. In certain embodiments, the actuator may be configured to incrementally change the position of the feed door 24 (e.g., in 0.1 mm increments; in 0.05 mm increments; and/or the like) between the closed configuration and the open configuration. Thus, the flow rate of granules through each feed chute 22 may be varied based at least in part on the positioning of the feed door 24.

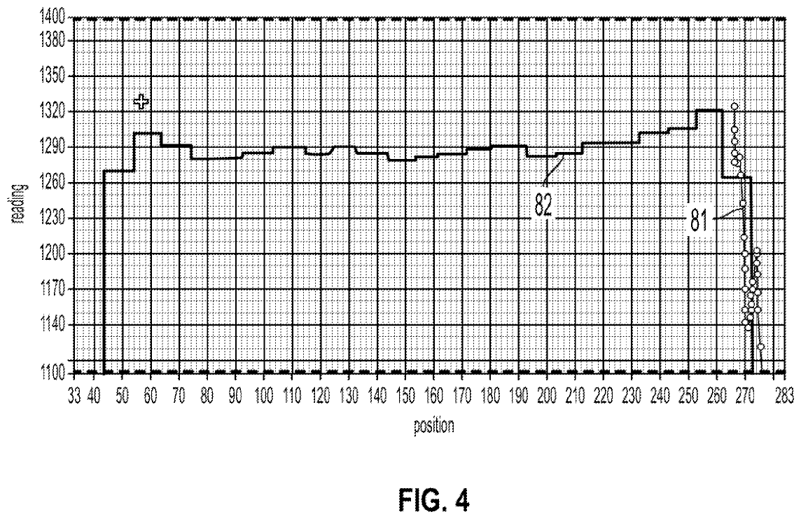

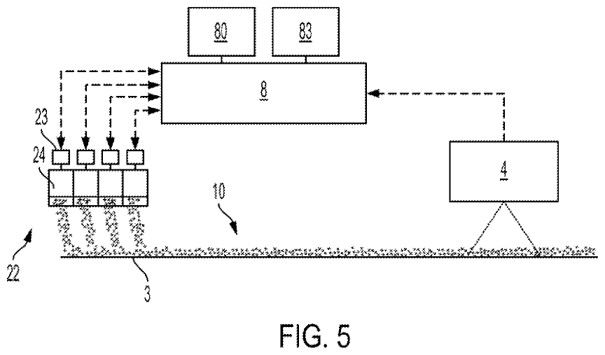

Moreover, in certain embodiments the actuator may comprise a feedback sensor, such as an encoder feedback sensor and/or a force feedback sensor configured to sense resistance against movement of the actuator. For example, the actuators may be embodied as motors 23 with integrated force feedback mechanisms to monitor the resistive force applied to counteract desired movement of the motor 23. In certain embodiments, the motors 23 may be configured to move to a desired position only when the resistive force applied to counteract the desired movement of the motor 23 is below a threshold level. Thus, the motors 23 may be configured for self-preservation to minimize the amount of wear experienced by the motors 23 during use and/or to detect pellet jams within the one or more feed chutes 22. In certain embodiments, the feedback sensor may be configured to generate a fault message to be provided back to a controller 8 (following the dashed lines shown between the controller 8 and the motors 23 as shown at FIG. 5), which may provide data indicative of the detected fault via a graphical display (e.g., a graphical display as illustrated in FIG. 4) such that a user may inspect the motor 23 generating the fault to take appropriate remedial action (e.g., cleaning the motor 23, feed door 24, and/or the like).

As yet another example, the feedback sensor may comprise a position feedback sensor (e.g., embodied as indexed servo motors or sensors secured relative to the feed doors 24) configured to monitor the position of the feed door 24. The position feedback sensor may be utilized to determine the current position of the feed door 24 and to compare the position of the feed door 24 against a desired position of the feed door 24, for example, as specified in a thickness profile.

As shown in FIG. 2, the granule dispenser 2 comprises a plurality of feed chutes 22 aligned across the width of the support conveyor 3. Each feed chute 22 is configured to dispense material granules onto a portion of the width of the support conveyor 3 (referred to herein as a “lane”). Each lane abuts an adjacent lane corresponding to an adjacent feed chute 22, such that the plurality of feed chutes 22 are collectively configured to dispense material granules across a continuous portion of the width of the support conveyor 3.

As shown in FIGS. 1 and 6A-6B and in the schematic diagram of FIG. 5, each granule dispenser 2 is controllable by a controller 8 (e.g., a computing entity comprising one or more non-transitory memory storage areas, a processing entity, one or more input ports, one or more output ports, one or more displays 80, and/or one or more user input interfaces 83). Although the embodiments of FIGS. 1 and 6A illustrate the apparatus 1, 101 comprising a plurality of discrete controllers 8 in communication with separate monitoring mechanisms 8 and granule dispensers 2, it should be understood that a single controller 8 (e.g., a single computing entity) may be configured to provide the functionality of the multiple controllers 8 shown in the figures (e.g., as shown in FIG. 6B), for separately monitoring detection signals received from various monitoring mechanisms 4 and for adjusting the functionality of the various granule dispensers 2, for example, based at least in part on the detection signals received from the monitoring mechanisms 4.

For example, each actuator corresponding to a particular feed chute 22 is controllable individually by the controller 8 based on control signals transmitted from the controller 8 to each actuator (e.g., motor 23) to adjust the rate of granule flow through the corresponding feed chute 22. For example, the controller 8 may be configured to determine that thickness of a particular lane of the formed granule bed 10, 11, 13 does not correspond to a desired thickness (as discussed herein), and may adjust the positioning of the corresponding feed door 24 to adjust the rate of granule dispensing to the particular lane to change the thickness of the resulting lane of the granule bed 10, 11, 13. As yet another example, the controller 8 may be configured to determine that the position of the feed door 24 does not correspond to a desired feed door position (and accordingly a desired granule bed thickness) and may adjust the positioning of the feed door 24 to adjust the rate of granule dispensing to the lane corresponding to the feed door 24.

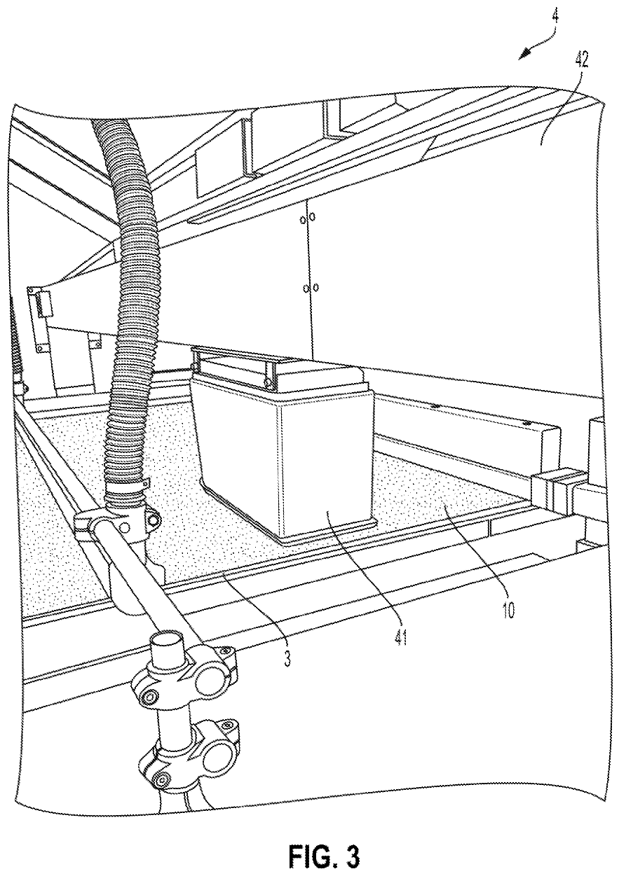

As shown in FIGS. 1, 5, and 6A-6B, the controllers 8 may be in communication with the thickness monitoring devices 4 to receive detection signals indicative of the measured thickness of the granule bed 10, 11, 13 at various locations across the width of the granule bed 10, 11, 13. FIG. 3 is a perspective view of an example thickness monitoring device 4 in accordance with various embodiments. It should be understood that the second thickness monitoring device 4 may have an analogous configuration. As shown in FIG. 3, the thickness monitoring device 4 comprises a monitoring head 41 configured to measure the thickness of the granule bed 10 via a non-contact measurement mechanism. For example, the monitoring head 41 may comprise a beta gauge sensor (or other non-contact thickness measurement sensor, such as other radiometric sensors (e.g., X-Ray, Gamma, and/or the like), a laser sensor, a capacitance sensor, an electric field sensor, an optical sensor, a machine-vision sensor, an infrared sensor, an ultrasonic sensor, a radar based sensor, and/or the like) configured to generate detection signals that may be correlated to a thickness of the granular bed 10. In the illustrated embodiment of FIG. 3, the monitoring head 41 of the beta gauge sensor is configured to traverse a gantry 42 positioned above the support conveyor 4 in a direction parallel with the width of the support conveyor 4. In certain embodiments, the monitoring head 41 may move together with a second monitoring head (not shown) positioned below the support conveyor 4. The two monitoring heads may comprise a beta particle emitter and a receiver, respectively, configured to detect the quantity of beta particles passing through the support conveyor 10 and the granular bed 10. The resulting generated detection signals from the illustrated beta gauge may be indicative of a granule bed thickness and/or a granule bed density.

The monitoring head 41 is configured to generate signals indicative of the thickness of the granule bed 10 at various positions across the width of the granule bed 10. Detection signals generated by the thickness monitoring device 4 may comprise data indicative of a measured thickness of the granule bed 10 (e.g., based on the detected quantity of beta particles passing through the granule bed 10) as well as a measurement position (e.g., a single-direction position indicative of the location across the width of the granule bed 10 or a dual-direction position indicative of the location across the width of the granule bed 10 and along the length of the granule bed 10 (determined based at least in part on the movement speed of the support conveyor 4)).

The generated detection signals are transmitted to the controller 8 as shown in FIG. 5, which is configured to monitor the granule bed thickness relative to a target thickness profile (e.g., stored in the non-transitory memory storage areas of the controller 8). The target thickness profile may be an at least substantially uniform thickness across the width of the granule bed 10 having a target thickness. However, it should be understood that the target thickness profile may define a non-uniform target thickness across the width of the granule bed 10 (having thickness peaks and/or valleys at defined locations across the width of the granule bed 10). Thus, the target thickness profile may be configured to account for various characteristics of down-stream processing mechanisms (e.g., uneven, crowning, or sagging nip rollers, uneven heating profiles for melting the granule bed, and/or the like) or to generate non-uniform thickness granule beds 10 as desired. In certain embodiments, the target thickness profile may be generated based at least in part on user input, or the target thickness profile may be automatically generated. Moreover, the controller 8 may be configured to store a plurality of target thickness profiles that may be individually selected for application for a particular granule bed. For example, the controller 8 may store a plurality of individually selectable target thickness profiles that may be applicable to corresponding granule types, desired granule bed thicknesses, and/or the like.

In certain embodiments, target thickness profiles may be generated for each granule bed 10, 11, 13, for each monitoring mechanism 4, for the multi-layer structure as a whole, and/or the like. Particularly for embodiments in which a plurality of monitoring mechanisms 4 are utilized in monitoring the thickness of components of a single granule bed (e.g., as illustrated in the embodiments of FIGS. 6A-6B, which utilize a plurality of monitoring mechanisms 4 for monitoring components of the first granule bed 10), the detection signals may be utilized to make adjustments to a plurality of granule dispensers 2 collectively (e.g., to make similar adjustments to multiple granule dispensers 2 simultaneously, based at least in part on a single detection signal), or to make adjustments to a plurality of granule dispensers 2 individually (e.g., to make independent adjustments to multiple granule dispensers 2, based at least in part on a plurality of detection signals). With reference briefly to the configurations of FIGS. 6A-6B for forming the first granule bed 10, detection signals generated from the monitoring mechanism 4 configured for monitoring the entire thickness of the first granule bed 10 may be utilized to make analogous adjustments to both granule dispensers 2 utilized to collectively form the first granule bed 10. For example, a detection signal from the monitoring mechanism 4 may be utilized to cause both granule dispensers 2 to open respective feed gates by an additional 0.2 mm. such that both granule dispensers 2 have similar gate opening configurations. Moreover, detection signals from the other monitoring mechanism 4 utilized to monitor the relative amount of granule material provided by the most-upstream granule dispenser 2 (the first granule dispenser 2) may be utilized to determine relative amounts of granule material provided by the first granule dispenser 2 and the second granule dispenser 2. Detection signals received from the monitoring mechanism positioned between the first granule dispenser 2 and the second granule dispenser 2 may cause one of the first granule dispenser 2 and the second granule dispenser 2 to adjust the amount of granule material provided independently. For example, detection signals from the monitoring mechanism 4 positioned between the first granule dispenser 2 and the second granule dispenser 2 may cause the first granule dispenser 2 to open feed gates by an additional 0.3 mm, without making a similar adjustment to the feed gates of the second granule dispenser 2.

In certain embodiments comprising multiple monitoring mechanisms 4 associated with the formation of a single granule bed, one monitoring mechanism 4 may be identified as a primary monitoring mechanism, and other monitoring mechanisms 4 may be identified as secondary monitoring mechanisms. In the example discussed above in reference to the first granule bed 10 of FIGS. 6A-6B, the monitoring mechanism 4 configured for monitoring the collective thickness of the first granule bed 10 may be identified as the primary monitoring mechanism, and the monitoring mechanism 4 configured for monitoring the thickness of granule material provided by the first granule dispenser 2 only may be identified as a secondary monitoring mechanism. The controller 8 may be configured to make changes to the configuration of the granule dispensers 2 (e.g., the opening of the feed gates) at different rates depending on the source of detection signals received. For example, detection signals received from the primary monitoring mechanism may be more quickly integrated as changes to the relative positioning of feed gates of the granule dispensers 2 than detection signals received from the secondary monitoring mechanism. In embodiments as discussed herein, wherein a moving average of detection signals are monitored prior to changing the positioning of feed gates, the controller may monitor a shorter timeframe moving average for detection signals received from the primary monitoring mechanism than the timeframe moving average for detection signals received from the secondary monitoring mechanism. As a specific example, the controller 8 may utilize a moving average based on the most recent 20 detection signals received from the primary monitoring mechanism, and the controller 8 may utilize a moving average based on the most recent 100 detection signals received from the secondary monitoring mechanism when determining whether to change the positioning of feed gates of the granule dispensers 2.

As shown in FIG. 4 which illustrates an example display associated with a controller 8, the controller 8 may be configured to map the detection signals received from the thickness monitoring device 4 in real-time. As shown in FIG. 4, the controller 8 may be configured to map the real-time thickness measurement data 81 as a function of position across the width of the granule bed 10. Moreover, the controller 8 may be configured to calculate a moving average granule bed thickness within each lane of the granule bed 10. The moving average granule bed thickness may be determined based upon a predefined number of data points, based on data points collected during a predefined number of passes of the monitoring head 41 across the width of the granule bed 10, and/or the like. The moving average data 82 may also be plotted as a function of position across the width of the granule bed 10.

The controller 8 may also store data indicative of the target thickness profile for the granule bed 10, and may be configured to compare the moving average data 82 against the target thickness profile. The controller 8 may be configured to continue monitoring the data upon determining that the moving average data 82 matches the target thickness profile (e.g., having a thickness within an acceptable tolerance of the target thickness). However, upon determining that the moving average data 82 differs from the target thickness profile (e.g., upon determining that the thickness of the moving average data 82 is above or below the acceptable tolerance level surrounding the target thickness profile), the controller 8 may be configured to transmit control signals to one or more feed chutes 22 (e.g., the actuators controlling the position of corresponding feed doors 24 of the one or more feed chutes 22) as shown in FIG. 5, to increase or decrease the rate of granule supply to the granule bed 10. For example, upon determining that a particular lane has a moving average thickness less than an acceptable thickness level, the controller 8 is configured to transmit a control signal to the feed chute 22 corresponding to the particular lane to move the corresponding feed gate 24 to a more open position to increase the rate of granule feed to the particular lane (thereby increasing the thickness of the granule bed at the particular lane). Likewise, upon determining that a particular lane has a moving average thickness greater than an acceptable thickness level, the controller 8 is configured to transmit a control signal to the feed chute 22 corresponding to the particular lane to move the corresponding feed gate 24 to a more closed position to decrease the rate of granule feed to the particular lane (thereby decreasing the thickness of the granule bed at the particular lane).

### CONCLUSION

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. An automated granule bed forming mechanism comprising:
a support conveyor configured for supporting a formed granule bed;
at least one granule dispenser configured for dispensing granules onto the support conveyor to form a granule bed, wherein the at least one granule dispenser comprises:
a plurality of feed chutes positioned across a width of the support conveyor, each of the plurality of feed chutes having an individually controllable feed door for controlling the flow rate of granules from the feed chute onto the support conveyor;
a thickness monitoring mechanism configured to monitor the thickness of the granule bed on the support conveyor; and
one or more controller configured to:
compare the detected thickness of the granule bed on the support conveyor relative to a target thickness profile; and
transmit signals to one or more of the individually controllable feed doors to adjust the flow rate of granules from the feed chute onto the support conveyor to adjust the thickness of the granule bed to correspond to the target thickness profile.

2. The automated granule bed forming mechanism according to claim 1, further comprising: a plurality of granulate dispensers, and wherein the one or more controller is embodied as a single controller configured to transmit signals to one or more of the individually controllable feed doors of each of the plurality of granulate dispensers.

3. The automated granule bed forming mechanism of claim 1, further comprising a plurality of granulate dispensers, and wherein the one or more controller is embodied as a plurality of controllers, each of the plurality of controllers is configured to transmit signals to one or more of the individually controllable feed doors of one or more of the plurality of granulate dispensers.

4. The automated granule bed forming mechanism of claim 1, further comprising a plurality of granulate dispensers, and wherein the one or more controller is embodied as a plurality of controllers, wherein each of the plurality of controllers corresponds to a corresponding controller of the plurality of granule dispensers, and wherein each of the plurality of controllers is configured to transmit signals to one or more of the individually controllable feed doors of the corresponding granule dispenser.

5. The automated granule bed forming mechanism of claim 1, wherein:
each of the feed chutes are configured to dispense granules onto a corresponding lane of the support conveyor; and
the one or more controller is configured to:
compare the detected thickness of the granule bed in each lane of the support conveyor relative to a target thickness profile; and
transmit a signal to an individually controllable feed door of a particular feed chute to adjust the flow rate of granules from the feed chute onto the corresponding lane.

6. The automated granule bed forming mechanism of claim 1, wherein the target thickness profile may define an at least substantially uniform thickness across a width of the granule bed.

7. The automated granule bed forming mechanism of claim 1, wherein the target thickness profile defines a non-uniform thickness across a width of the granule bed.

8. The automated granule bed forming mechanism of claim 1, wherein each of the plurality of individually controllable feed doors are movable via a corresponding motor.

9. The automated granule bed forming mechanism of claim 8, wherein each motor comprises a feedback mechanism configured to detect resistive forces counteracting a desired movement of the motor.

10. The automated granule bed forming mechanism of claim 9, wherein the feedback mechanism comprises a force feedback mechanism.

11. The automated granule bed forming mechanism of claim 9, wherein the feedback mechanism comprises a position feedback mechanism configured to detect the position of the feed door between the open configuration and the closed configuration.

12. A method for forming a granule bed, the method comprising:
moving a support conveyor past at least one granule dispenser;
dispensing granules from a plurality of feed chutes positioned across a width of the support conveyor to form a granule bed, wherein each of the plurality of feed chutes has an individually controllable feed door for controlling the flow rate of the granules flowing from the feed chute onto the support conveyor;
detecting the thickness of the granule bed via a thickness monitoring mechanism;
comparing the detected thickness of the granule bed relative to a target thickness profile; and
adjusting one or more of the feed doors of the plurality of feed chutes to adjust the flow rate of granules from the feed chute onto the support conveyor to adjust the thickness of the granule bed to correspond to the target thickness profile.

13. The method of claim 12, wherein dispensing granules from a plurality of feed chutes comprises dispensing granules into a plurality of lanes on the support conveyor, wherein each feed chute of the plurality of feed chutes corresponds to a single lane of the plurality of lanes; and
wherein comparing the detected thickness of the granule bed relative to the target thickness comprises comparing the detected thickness of the granule bed in each lane relative to the target thickness profile.

14. The method of claim 12, wherein the target thickness profile may define an at least substantially uniform thickness across a width of the granule bed.

15. The method of claim 12, wherein the target thickness profile defines a non-uniform thickness across a width of the granule bed.

16. The method of claim 12, wherein adjusting one or more of the feed doors of the plurality of feed chutes comprises actuating a motor corresponding to each of the one or more feed doors.

17. The method of claim 16, further comprising receiving a feedback signal from one or more of the motors to detect a position of the one or more feed doors; and
wherein adjusting one or more of the feed doors comprises moving the one or more of the feed doors to a desired position based at least in part on the feedback signal.

18. A controller for an automated granule bed forming mechanism, the controller comprising one or more memory storage areas and at least one processor configured to:
transmit a signal to a plurality of individually controllable feed doors of corresponding feed chutes of a plurality of feed chutes of a granule dispenser to control a flowrate of granules from the feed chute onto a support conveyor, wherein the plurality of feed chutes are positioned across a width of the support conveyor;
detecting a thickness of a granule bed formed on the support conveyor from granules flowing from the plurality of feed chutes;
comparing the detected thickness of the granule bed on the support conveyor relative to a target thickness profile; and
transmitting a second signal to the plurality of individually controllable feed doors to adjust the flowrate of granules from the feed chute.

19. The controller of claim 18, wherein each of the feed chutes are configured to dispense granules onto a corresponding lane of the support conveyor; and wherein:
comparing the detected thickness of the granule bed on the support conveyor relative to the target thickness profile comprises comparing the detected thickness of the granule bed in each lane of the support conveyor relative to the target thickness profile; and
transmitting the second signal to the plurality of individually controllable feed doors comprises transmitting the second signal to the plurality of individually controllable feed doors to adjust the flow rate of granules from the feed chute onto the corresponding lane.

20. The controller of claim 18, wherein the at least one processor is additionally configured to receive a feedback signal from one or more feed doors; and
wherein adjusting one or more of the feed doors comprises moving the one or more of the feed doors to a desired position based at least in part on the feedback signal.
